(19) United States
(12) Patent Application Publication
(10) Pub. No.: US 2026/0093736 A1
(43) Pub. Date: Apr. 2, 2026

(54) DATABASE KNOWLEDGE RETRIEVAL THROUGH PATH EXPLORATION PREDICTION

(71) Applicant: Dell Products L.P., Round Rock, TX (US)

(72) Inventors: Juarez Monteiro dos Santos Júnior, Cidreira (BR); David Burth Kurka, Campinas (BR); Iam Palatnik de Sousa, Rio de Janeiro (BR); Pedro Fratini Chem, Porto Alegre (BR)

(21) Appl. No.: 18/901,583

(22) Filed: Sep. 30, 2024

(51) Int. Cl. G06F 16/33; G06F 16/332; G06F 16/338; G06F 16/35

(52) U.S. Cl. CPC G06F 16/3344; G06F 16/3326; G06F 16/338; G06F 16/355

(57) ABSTRACT

Information retrieval systems and methods are disclosed. A dataset is processed to generate an exploration database of representative exploration paths. Each exploration path includes a representative question and a corresponding answer generated or verified by a domain expert. When the dataset is queried by a user, the user is given an option to replace their original query with a representative query that is associated with an answer. If the representative query is selected, the answer that is already generated may be presented to the user. The representative query is determined by searching the exploration database using the user's original query to identify the closest representative queries.

### TECHNOLOGICAL FIELD OF THE DISCLOSURE

Embodiments disclosed herein generally relate to information retrieval. More particularly, at least some embodiments relate to systems, hardware, software, computer-readable media, and methods for interactive information retrieval.

### BACKGROUND

There are many scenarios in which documentation is generated. For example, computing products are often associated with documents such as manuals and tutorials. These documents are often intended, for example, to help users learn best usage practices, perform troubleshooting, and perform product optimizations. However, users often face challenges when trying to retrieve information from the documents, particularly when the documents are online.

Common paradigms for connecting users to documents include information retrieval (IR), hybrid search (HS), and retrieval augmented generation (RAG). Even if these paradigms connect users to documents, users are highly impacted by the latency and/or quality of the retrieval operations. Various techniques, such as summarization and classification, have been tried to enhance the qualify of IR and RAG-like pipelines. However, each of these techniques introduces both complexity and additional latency.

Information retrieval systems based on large language models (LLMs) also introduce the risk of inconsistent information. LLMs, for example, are known to hallucinate in certain instances, which results in incorrect and non-sensical results.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of information retrieval that includes a pre-processing phase and an inference phase;

FIG. 2 discloses additional aspects of the pre-processing phase;

FIG. 3 discloses additional aspects of the inference phase; and

FIG. 4 discloses aspects of a computing device, system, or entity.

### DETAILED DESCRIPTION OF SOME EXAMPLE EMBODIMENTS

Embodiments disclosed herein generally relate to information retrieval. More particularly, at least some embodiments relate to systems, hardware, software, computer-readable media, and methods for interactive information retrieval for general and/or specialized users.

Embodiments of the invention are discussed in the context of retrieval augmented generation (RAG), but are not limited thereto and may be implemented in information retrieval systems or other systems that access data or information or that generate a response to a query. Example embodiments of the invention enhance information retrieval operations by including human-generated answers, thereby improving accuracy, and by reducing the time required to generate an answer or response to a query.

Generally, embodiments of the invention may be implemented with respect to a dataset. The dataset represents a source of knowledge that can be queried. A user may pose a question and the information retrieval system may access the dataset to determine an answer to the question. Embodiments of the invention improve this process by pre-processing the dataset to identify representative questions based on an analysis of the dataset. These questions can be answered by a human. Thus, representative questions along with human generated answers can be stored in advance. Thus, the answer is, in effect, prefetched. When the information retrieval system is deployed, a query that is similar to one of the representative questions can be answered with the prefetched answer or response. Thus, accuracy is improved using an answer generated by a human (e.g., a domain-expert). Latency is reduced because the answer does is already available and does not need to be generated.

Large language models (LLMs) are examples of neural networks that are able to perform, by way of example, natural language processing (NLP). LLMs can be adapted to a wide variety of different tasks that include, but are not limited to, text generation, chatbots, summarization, and information retrieval.

RAG systems may employ LLMs and are typically configured to allow users to interact with a database or other dataset. By integrating LLMs with RAG systems (or other information retrieval systems or data access systems), the knowledge and answer capabilities of the LLMs are extended. LLMs can be used to generate answers for questions using knowledge contained in any document (or dataset) available to the LLM.

Embodiments of the invention are described in the context of a domain specific dataset such as product manuals of an organization's products. Each manual may correspond to a particular product and each product may be associated with one or more manuals. Embodiments of the invention relate to retrieving information from this set of documents (e.g. a dataset of product manuals).

Given a domain specific dataset such as product manuals, embodiments of the invention may use LLMs to predict possible exploration paths within the domain specific dataset. The most relevant exploration paths (or paths of interaction) can be annotated. An indexed structure can be constructed to aid content exploration and speed up the knowledge retrieval process.

This exploration database may be constructed by processing documents available in the system to extract document sections. Using a LLM (or other model), a set of plausible questions that can be answered by each extracted section is generated or created. Questions and answers may be grouped using a clustering operation. For each group of similar questions (e.g., each cluster), a representative question is identified. In one example, a domain-specialist receives the representative questions and provides answers to the representative questions. This may be performed by the domain-specialist in the context of the relevant sections associated to or with each of the representative sections.

After generating and storing the data obtained in the pre-processing phase in the exploration database, an inference phase may be performed. The inference phase focuses on searching and retrieving the most similar question in the exploration database in the context of a user query. After searching the exploration database, embodiments of the invention may present the user with the most similar representative question retrieved from the exploration database and give the user the option of selecting the retrieved representative question in place of the user's original query. If the user accepts the replacement query, embodiments of the invention can retrieve the answer more quickly compared to traditional RAG systems because the answer has already been determined and prefetched. In addition, embodiments of the invention are supporting the user in obtaining an answer to their questions with an answer that was generated by a domain-specialist. As a result, the answer is likely to be more accurate and reliable than a standard LLM-based answer to the user's query.

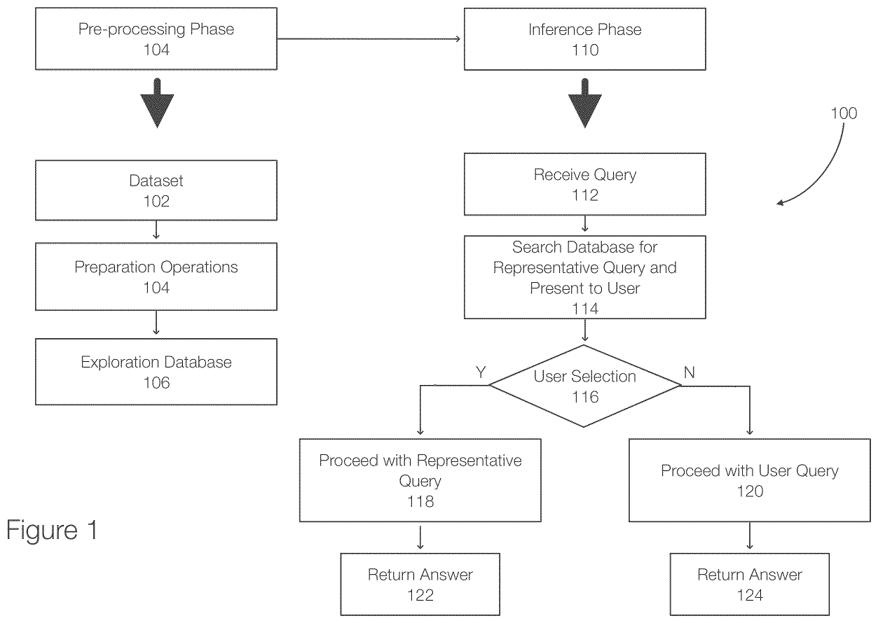

FIG. 1 generally illustrates an example of information retrieval systems and methods. The method 100, which may be implemented in a computing system (e.g., cloud-based, edge-based, on-premise or combinations thereof), is configured to perform information retrieval with respect to a dataset 102. In the method 100, the pre-processing phase 104 is a preparatory phase that prepares the system for performing information retrieval in response to user queries.

The pre-processing phase 104 and the inference phase 110 can be performed independently. Thus, the pre-processing phase is generally performed once while the inference phase 110, which is performed after the pre-processing phase 104 is completed, may be performed for each query. However, aspects of the pre-pre-processing phase 104 may be performed multiple times as new documents are generated, existing documents are amended/removed, and the like. The inference phase 110 may be relevant to users inside and/or outside of the organization.

In one example, a dataset 102 is typically identified or selected. In one example, the dataset 102 may be a set of product manuals for products of a particular organization. Once the dataset 102 for the information retrieval system is identified, preparation operations 104 are performed. Preparation operations 104 may include chunking operations to chunk the documents (or other data) in the dataset 102, question generation operations, clustering operations, indexing questions, question answer generation operations, and storing exploration or interaction paths (e.g., (question, sources (specific documents or sections thereof), answer)).

The result of the preparation operations 104 is an exploration database 106. The exploration database 106 may store information in various forms and may relate a question to both sources, documents, or sections in the dataset, and an answer to the question.

Once the exploration database 106 is prepared, the inference phase 110 may be performed. In the inference phase 110, a query (e.g., question) is received 112. The exploration 106 may be searched based on the received query for a representative query (e.g., representative question). The user may be presented 114 with the option to replace their query with the representative query. If the user selects the representative query (Y at 116), the method 100 proceeds 118 with the representative query and returns an answer 122 that was already generated and stored in the exploration database 1-6. The answer 122 may be generated by a domain-expert during the pre-processing phase 104. If the user elects to proceed 120 with the original user query (N at 116), an answer 124 is generated and returned. The answer 124 may be generated by an LLM using the dataset 102. The prefetched answer can be returned more quickly because the prefetched answer is already generated and stored while the answer to the user's original query must be generated.

Embodiments of the invention include generating exploration paths or paths of interaction with respect to a dataset, such as the dataset 102, within a framework such as an RAG framework in one example. The exploration paths are obtained or generated, in one example, using LLMs to predict user behavior and clustering operations to identify representative questions within or with respect to a dataset or database.

Embodiments of the invention improve information retrieval systems, including RAG systems, in multiple manners. For example, the performance of the information retrieval (or knowledge exploration) is improved by using workflows that are preprocessed and prefetched. In effect, a workflow for a representative query is performed in advance and stored.

Embodiments of the invention assist a user in discovering knowledge stored in the dataset by guiding the exploration of the dataset and by identifying common interaction or exploration paths with respect to the dataset.

In addition, the user is provided with access to reliable answers that originated with or are verified by domain specialists.

Embodiments of the invention may not rely on any form of model training or weight updates. The dataset may be explored in an unsupervised manner. Using exploration paths provides a unique may to introduce answers from domain specialists into the framework or architecture of the information retrieval system. More specifically, the use of LLMs ensures that the domain-specialists provide answers to human-like questions that are correlated to a specific context. The use of clustering operations to identify representative questions ensures diversity and broad coverage of the questions that are selected for annotation by domain experts.

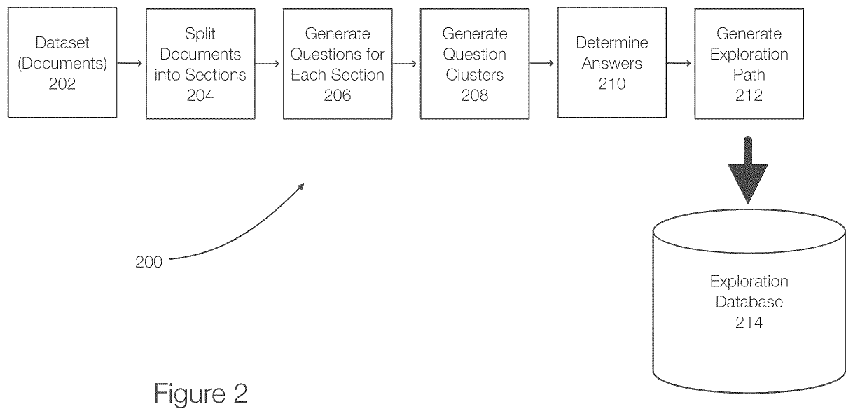

FIG. 2 discloses additional aspects of a pre-processing phase. In the method 200, a dataset (e.g., documents) is identified 202 or selected. In one example, the dataset is a collection of documents. In the method 200, the documents are chunked or split 204 into sections. More specifically, given a collection of documents D, each document dᵢ is chunked or split into sections Sᵢ In this example, the set of sections S includes all sections extracted or generated from all documents in D.

Once the documents are split 204 or chunked, questions are generated 206 for each section. More specifically, for each section i in S, a set of questions Qi related to the section i is generated using a question model M_{q}, which may be an LLM. Thus, Q is a set containing all questions generated from all sections in S. The number of questions generated for each section may vary and may depend on the question model.

Next, question (or query) clusters are generated 208. More specifically, using a clustering model or algorithm M_{c}, similar questions q in Q are grouped into clusters. For each of the question clusters, a representative question is extracted to form a new set or representative questions Q′. Thus, the set of representative questions contains pairs (q′ᵢ, Sᵢ), where q′ᵢ is a representative question for a cluster i and Sᵢ is the set of corresponding sections in S associated to all questions in cluster i.

Next, answers are determined 210 and/or prefetched. In this example, for each pair of representative question q′ᵢ and sections Sᵢ, an answer at is obtained using a human in the loop system powered by a domain specialist. These answers generated by the domain specialist can be prefetched, stored, and used when the user selects to proceed with the representative question in the inference phase.

In one example, rather than prefetching all questions in Q′ᵢ a selection of the most relevant questions for which the relevant answers are prefetched may be defined. The selected questions in this example may be based on user popularity or cluster size.

Once the answers generated by the domain specialist are determined 210, exploration (or interaction) paths are generated 212 and stored in an exploration database 214. The exploration path, in one example, is represented by a triple (q′ᵢ, Sᵢ, aᵢ) in the exploration database 214. The set of representative questions Q′ is indexed in a searchable index (vector or lexical database in some examples). The triple is an example of an exploration path and includes a representative question, the sources associated with the representative question, and an answer to the representative question.

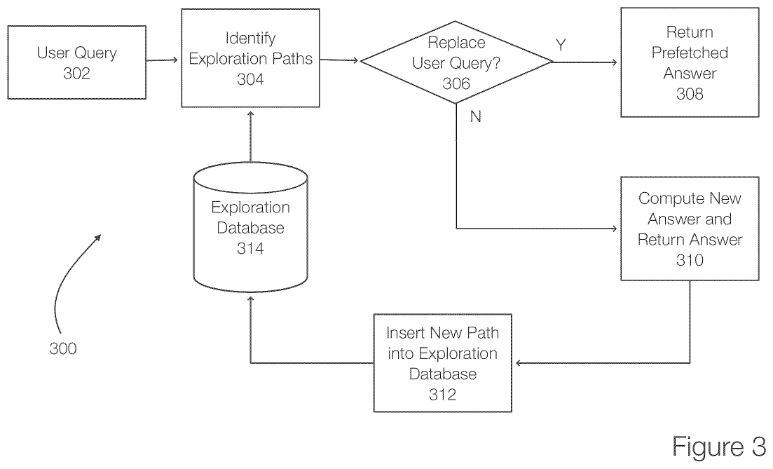

FIG. 3 discloses additional aspects of the inference phase. FIG. 3 illustrates an example inference method 300. In the method 300, a user query 302 is received via a user interface of a computing system configured to perform information retrieval. Using the query, paths in the exploration database 314 are searched to find or identify the most similar questions (e.g., k most similar questions). The value of k may be set by the system, by a domain expert, by default, or the like.

More specifically, given a user query r, the k most similar questions to r in Q′ are identified. The set P^{r} containing the exploration paths containing the k most similar questions is returned using the user query. Next, a replacement operation is performed at 306. The user is given the opportunity to replace the query r with a specific question q contained in a triple (p^{r}=(q, S, a)), which is a member of the set P^{r}. In one example, the user may be presented with the k similar questions and allowed to select one of these questions.

If the user agrees with the replacement (Y at 306) or selects one of the k questions, the prefetched answer from the corresponding triple (p^{r}=(q, S, a) is returned 308 and presented to the user. In one example, the sources or sections may also be provided. Thus, the answer a along with sources S is returned in one example. If the user does not agree with the replacement (N at 306), a standard information retrieval operation is performed (e.g., an RAG process). The answer is computed and the answer a^{r} and sources S^{r} are returned 310.

In one example, a new path may be inserted 312 into the exploration database 314. The new path may be the exploration just performed (p^{r}=(r, a^{r}, S^{r}) in response to the user choosing to submit their original query. In one example, the triples associated with scenarios where the user does not elect the replacement question may be stored. This may also (e.g., after a certain number of triples have been accumulated) allow the pre-processing phase to be performed in a manner that accounts for the new user preferred triples. This may result in new cluster, new replacement questions, and the like. In one example, a new path is added only when performed a threshold number of times.

In one example, a model may be configured or responsible for generating a set of questions for a particular section. In one example, the model may be an autoregressive LLM. Example models include Model GPT-4, Mixtral-8x-22B and Claude 3. These models are capable and of formulating several questions for a given context.

In addition, various prompt engineering techniques may be used to adjust the output of the models. This is beneficial and allows more control over the questions being generated. For example, prompt engineering techniques can require the generated questions to follow the same guidelines (e.g., short, concise, and not too specific). By combining large language models with prompt engineering techniques, human like questions that follow the same pattern are generated and can be compared to one another.

Various models may also be used for clustering operations. Generally, different clustering algorithms may be used, for example when suitable for textual embeddings. An example clustering algorithm is the K-means algorithm over the embeddings of questions. Embeddings of the questions can be computed with the use of sentence embedding models such as the all-MiniLM-L6-v2 and the all-mpnet-base-v2. From the embeddings of each question in the set Q, similar questions are grouped together by the selected unsupervised clustering algorithm.

In the question Indexing step of the pre-processing phase, after forming the clusters, representative questions and associated sources of each cluster are extracted. The representative questions are the median data points of each cluster in one example, and the associated sources (or sections) are the sources present in or associated with that cluster.

In some example embodiments, a domain specialist may be responsible for providing answers to representative questions extracted in the indexing aspect of the pre-processing phase. This ensures the accuracy and reliability of the answers and improves the performance of the information retrieval system. In some embodiments, the answers to the representative questions may be provided using an LLM. Even in this example, performance is improved because the answer has already been prefetched and stored in the exploration database. In another example, domain specialists may simply verify the answers provided by the LLM to the representative questions, which alleviates some of the manual work performed by the domain-specialists.

For example, users may want to search for or have a specific question about a product and referring to the product's manual is a good way to fine a reliable answer. Using a conventional RAG system allows a user to interact with the manuals. However, this approach relies on LLMs, which can hallucinate and produce incorrect answers. This undermines the reliability of consulting trustworthy sources, such as product manuals.

Embodiments of the invention thus improve on conventional information retrieval systems. For instance, during a pre-processing phase, all product manuals for a company's products may be split into sections. A large language model may be used to formulate questions about each of these sections.

One possible prompt for the language model could be constructed as the following example:

“Bellow is a section of a product manual from company X. Using the section as context, formulate 3 questions that beginner, intermediate, and experienced users could ask about that section. The questions should be relevant to the given context and capture most of its content. Keep the questions concise.

Large language models are able to abide with the response and may generate 3 relevant questions to a specific manual section.

Next, all questions produced by the model are transformed into embeddings via a sentence embeddings model. This ensures that semantically similar questions are close to each other in the embeddings space. The model all-MiniLM-L6-v2 is an example of suitable model for this task.

Next, a clustering algorithm groups the embeddings of the questions into clusters. In this case, the K-means algorithm is an example of an appropriate algorithm due to its simplicity and effectiveness. Also, the number of clusters could be defined using standard techniques such as the elbow method.

After the clusters are formed, the medoids of each cluster can be extracted to form the representative questions. Each representative question has a group of associated sources (document sections). These associated sources are formed by all the sources (sections) that originated the questions on the representative question's cluster.

For this example, product specialists of a company X provide answers for the set of representative questions. Finally, the set of representative questions, their associated sources, and the answers provided by the product specialists are all stored in an exploration database.

The inference phase allows users to make queries. When users have a question about a product, the user may not know exactly what terms to search for, or how to best explore a search function. For instance, a user may want to perform what they expect to be a hard reset on an computing system. However, the correct term can be different from what the user expects. For example, the term in the product manual may be “cold reset” rather than “hard reset”.

Assuming that the user does not know the correct term for resetting the system, the following question or query may be submitted: “How to perform a hard reset on the computing system B?”.

The inference phase may begin by converting the user question to embeddings (e.g., using the same all-MiniLM-L6-v2 embeddings model) and retrieving the most similar embeddings of relevant or representative questions stored in the exploration database. The embeddings of the relevant questions would be converted to text and presented to the user. The user is given the opportunity to change their question to one of the presented relevant questions. For the case of this example, one of the relevant or representative questions may be: “How to reset the computing system B?”.

If the user chooses to switch to the representative question, the system will immediately return the stored answer, written or verified by a domain specialist. Otherwise, the system would execute the standard RAG pipeline with the user's original prompt.

For the latter case where the original query or original prompt is used, there is no guarantee that the RAC pipeline would be able to generate a correct answer for the user, especially considering that the question contains the term “hard reset” and the manual uses the term “cold reset”, which can cause the LLM to produce an unexpected answer. In contrast, if the user opts for the suggested relevant or representative question, the user would receive an accurate answer written or verified by a domain specialist.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, machine learning related operations, information retrieval operations, NLP operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a query from a user into an information retrieval system via a user interface, the information retrieval system including a dataset, performing a search in an exploration database based on the query to identify a representative query, wherein the exploration database stores tuples and each tuple includes a representative query and an answer to the representative query, presenting an option to proceed with the representative query generated by the search or with the query received from the user, receiving input selecting the representative query, and retrieving and presenting an answer associated with the representative query in the user interface, wherein the answer is retrieved from the data.

Embodiment 2. The method of embodiment 1, wherein the tuple is a triple and further comprises sources associated with the representative query and the answer, wherein the dataset comprises a set of documents.

Embodiment 3. The method of embodiment 1 and/or 2, wherein the answer is generated by a domain specialist.

Embodiment 4. The method of embodiment 1, 2, and/or 3, wherein the answer is generated by a large language model and verified by a domain specialist.

Embodiment 5. The method of embodiment 1, 2, 3, and/or 4, further comprising generating an answer using the dataset when the input selects the query from the user.

Embodiment 6. The method of embodiment 1, 2, 3, 4, and/or 5, further comprising adding a new exploration path to the exploration database based on the query from the user, sources used to generate the answer, and the answer.

Embodiment 7. The method of embodiment 1, 2, 3, 4, 5, and/or 6, wherein the option allows the user to select the query or the user or select a representative query from a list of k representative queries, wherein the list of k representative queries are representative queries in the exploration database that are most similar to the query of the user.

Embodiment 8. The method of embodiment 1, 2, 3, 4, 5, 6, and/or 7, further comprising generating the exploration database by performing preparation operations on the dataset.

Embodiment 9. The method of embodiment 1, 2, 3, 4, 5, 6, 7, and/or 8, wherein the preparation operations include chunking documents included in the dataset into sections.

Embodiment 10. The method of embodiment 1, 2, 3, 4, 5, 6, 7, 8, and/or 9, wherein the preparation operations further include generating one or more queries for each of the sections to generate a set of queries, clustering the set of queries to identify clusters of queries, selecting a representative query from each of the clusters, and generating an answer for each of the representative queries.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

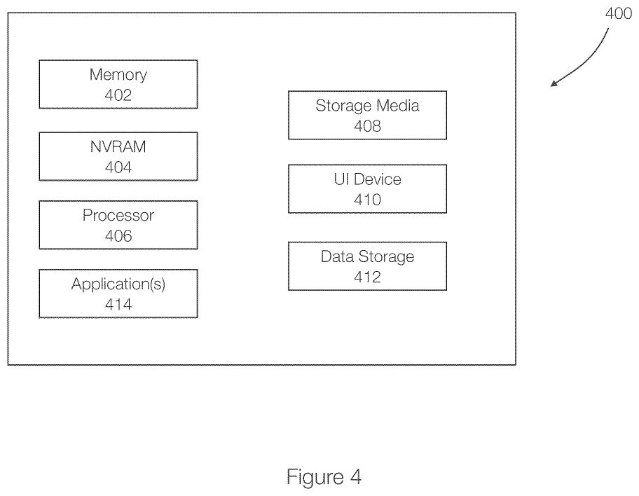

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

The device 400 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may also represent a physical or virtual machine or server, an edge-based computing system, a cloud-based computing system, server clusters or other computing systems or environments. The device 400 may also represent multiple machines or devices, whether virtual, containerized, or physical. The device 400 may perform or execute steps or acts of the methods illustrated in the Figures. The device 400 may also represent a client-server computing environment, which may be present in networks including the Internet.

The described embodiments are to be considered in all respects only as illustrative and not restrictive. All changes which come within the meaning and range of equivalency of the claims are to be embraced within their scope.

What is claimed is:

1. A method comprising:
receiving a query from a user into an information retrieval system via a user interface, the information retrieval system including a dataset;
performing a search in an exploration database based on the query to identify a representative query, wherein the exploration database stores tuples and each tuple includes a representative query and an answer to the representative query;
presenting an option to proceed with the representative query generated by the search or with the query received from the user;
receiving input selecting the representative query; and
retrieving and presenting an answer associated with the representative query in the user interface, wherein the answer is retrieved from the data.

2. The method of claim 1, wherein the tuple is a triple and further comprises sources associated with the representative query and the answer, wherein the dataset comprises a set of documents.

3. The method of claim 1, wherein the answer is generated by a domain specialist.

4. The method of claim 1, wherein the answer is generated by a large language model and verified by a domain specialist.

5. The method of claim 1, further comprising generating an answer using the dataset when the input selects the query from the user.

6. The method of claim 5, further comprising adding a new exploration path to the exploration database based on the query from the user, sources used to generate the answer, and the answer.

7. The method of claim 1, wherein the option allows the user to select the query or the user or select a representative query from a list of k representative queries, wherein the list of k representative queries are representative queries in the exploration database that are most similar to the query of the user.

8. The method of claim 1, further comprising generating the exploration database by performing preparation operations on the dataset.

9. The method of claim 8, wherein the preparation operations include chunking documents included in the dataset into sections.

10. The method of claim 9, wherein the preparation operations further include generating one or more queries for each of the sections to generate a set of queries, clustering the set of queries to identify clusters of queries, selecting a representative query from each of the clusters, and generating an answer for each of the representative queries.

11. A non-transitory storage medium having stored therein instructions that are executable by one or more hardware processors to perform operations comprising:
receiving a query from a user into an information retrieval system via a user interface, the information retrieval system including a dataset;
performing a search in an exploration database based on the query to identify a representative query, wherein the exploration database stores tuples and each tuple includes a representative query and an answer to the representative query;
presenting an option to proceed with the representative query generated by the search or with the query received from the user;
receiving input selecting the representative query; and
retrieving and presenting an answer associated with the representative query in the user interface, wherein the answer is retrieved from the data.

12. The non-transitory storage medium of claim 11, wherein the tuple is a triple and further comprises sources associated with the representative query and the answer, wherein the dataset comprises a set of documents.

13. The non-transitory storage medium of claim 11, wherein the answer is generated by a domain specialist.

14. The non-transitory storage medium of claim 11, wherein the answer is generated by a large language model and verified by a domain specialist.

15. The non-transitory storage medium of claim 11, further comprising generating an answer using the dataset when the input selects the query from the user.

16. The non-transitory storage medium of claim 15, further comprising adding a new exploration path to the exploration database based on the query from the user, sources used to generate the answer, and the answer.

17. The non-transitory storage medium of claim 11, wherein the option allows the user to select the query or the user or select a representative query from a list of k representative queries, wherein the list of k representative queries are representative queries in the exploration database that are most similar to the query of the user.

18. The non-transitory storage medium of claim 11, further comprising generating the exploration database by performing preparation operations on the dataset.

19. The non-transitory storage medium of claim 18, wherein the preparation operations include chunking documents included in the dataset into sections.

20. The non-transitory storage medium of claim 19, wherein the preparation operations further include generating one or more queries for each of the sections to generate a set of queries, clustering the set of queries to identify clusters of queries, selecting a representative query from each of the clusters, and generating an answer for each of the representative queries.
